(19) United States
(12) Patent Application Publication
(10) Pub. No.: US 2008/0303278 A1
(43) Pub. Date: Dec. 11, 2008

(54) DEVICE FOR PIPE COUPLING

(76) Inventor: Ming-Yi Lee, Taipei City (TW)

Correspondence Address: LEONG C LEI, PMB # 1008, 1867 YGNACIO VALLEY ROAD, WALNUT CREEK, CA, 94598, US

(21) Appl. No.: 11/759,243

(22) Filed: Jun. 7, 2007

(51) Int. Cl. F16L 19/04

(52) U.S. Cl. 285/382.7

(57) ABSTRACT

To couple a giving end of a first pipe and an receiving end of a second pipe, the device contains a rubber ring, a tubular screw, a C-shaped ring, and a rubber washer. The C-shaped ring is embedded in a groove of the giving end of the first pipe which is threaded through the rubber ring, the tubular screw and the rubber washer and is plugged into the receiving end of second pipe. Inside the tubular screw, the diameter is gradually shrunk to form a born-shaped space with a slant wall. When the tubular screw is screwed into the receiving end of the second pipe, the slant wall forces the C-shaped ring, and thereby the giving end of the first pipe, to gradually advance. In the mean time, the bottom of the tubular screw presses the rubber washer tightly against the second pipe to effectively prevent leakage.

### TECHNICAL FIELD OF THE INVENTION

The present invention generally relates to pipe coupling, and more particularly to a pipe coupling device capable of withstanding the difference in thermal expansion/contraction under temperature changes.

### DESCRIPTION OF THE PRIOR ART

Pipe coupling is common in plumbing. The most important objective in pipe coupling is the prevention of leakage, and the conventional idea in pipe coupling techniques is therefore always about achieving the greatest degree of tightness.

However, rigidly locking the pipes together to achieve tightness is not a satisfactory solution as gaps in the coupling interface is unavoidable when the pipes undergo temperature changes and expand/contract differently. Under these circumferences, the rigid locking of the pipes would fail to compensate the developed gaps flexibly.

### SUMMARY OF THE INVENTION

Accordingly, a novel device is provided herein to obviate the foregoing shortcomings of conventional pipe coupling.

To couple a giving end of a first pipe and an receiving end of a second pipe, the device contains a rubber ring, a tubular screw, a C-shaped ring, and a rubber washer. The C-shaped ring is embedded in a groove of the giving end of the first pipe which is threaded through the rubber ring, the tubular screw and the rubber washer. The giving end of the first pipe is then plugged into the receiving end of second pipe.

Inside the tubular screw, the diameter is gradually shrink to form a horn-shaped space with slant wall. When the tubular screw is screwed into the receiving end of the second pipe, the slant wall forces the C-shaped ring, and thereby the giving end of the first pipe, to gradually advance. In the mean time, the bottom of the tubular screw presses the rubber washer tightly against the second pipe to effectively prevent leakage.

A major feature of the present invention lies in the provision of the horn-shaped space inside the tubular screw. The space provides an adequate tolerance to compensate the differences in thermal expansion or contraction when the pipe coupling undergoes temperature variations. In addition to temperature change, the tolerance provided by the present invention would also allow the pipe coupling to withstand the variations caused by physical impact.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded diagram showing the various components of a pipe coupling device according to an embodiment of the present invention.

FIG. 2 is a top-view diagram showing the tubular screw of FIG. 1.

FIG. 3 is a section-view diagram showing the tubular screw of FIG. 1.

FIGS. 4, 5, and 6 are perspective diagrams showing a number of embodiments of the tubular screw of FIG. 1.

FIG. 7 is a section-view diagram showing the coupling of a first pipe and a second pipe by the pipe coupling device of FIG. 1.

FIG. 8 is an enlarge-view diagram showing the details inside the tubular screw of FIG. 7.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

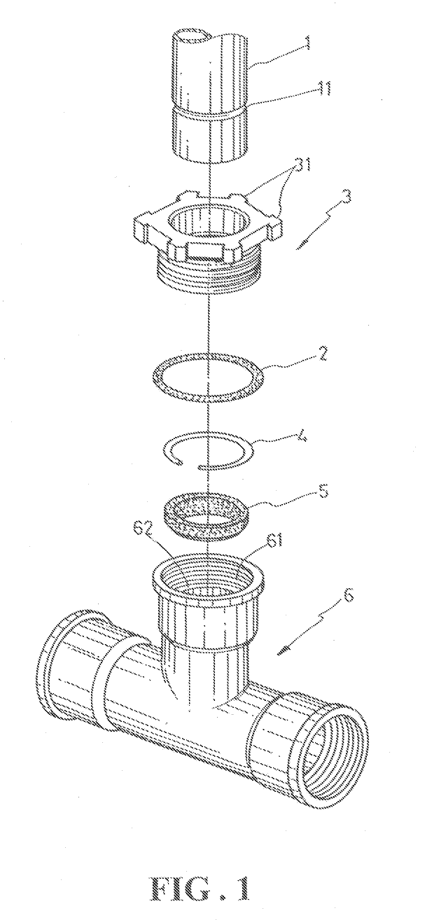

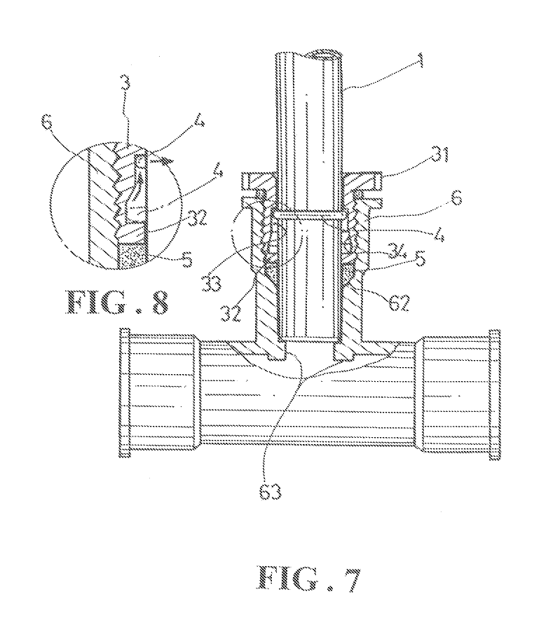

As shown in FIG. 1, and embodiment of the present invention for coupling a giving end of a first pipe 1 and an receiving end of a second pipe 6 contains a rubber ring 2, a tubular screw 3, a C-shaped ring 4, and a rubber washer 5. At an appropriate location along the giving end of the firs pipe 1, a circular groove 11 is provided around the first pipe 1 for the embedment of the C-shaped ring 4. On the other hand, there are threads 61 provided around the inner wall of the receiving end of the second pipe 6 and, further into the receiving end and behind the threads 61, the diameter of the inner wall of the receiving end is gradually shrunk to form a slant section 62. Then, a circular flange 63 is provided around the inner wall at the other end of the second pipe 6 (see FIG. 7).

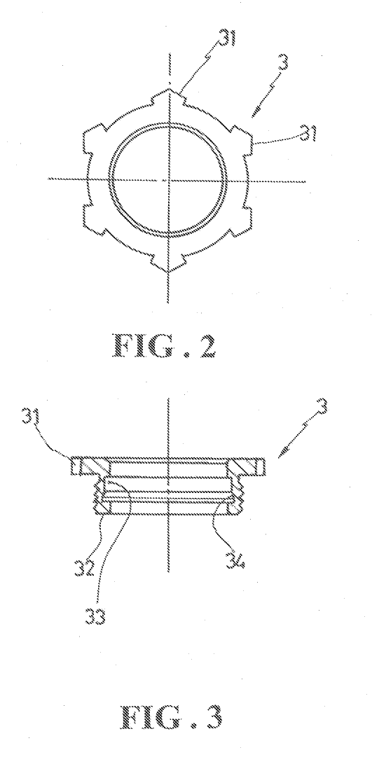

As further shown in FIGS. 2 and 3, the tubular screw 3 contains a tubular body having threads around the outer circumference and a twisting knob with a number of bulges 31 at an end of the tubular body. Inside the tubular body, the diameter is gradually shrunk towards the end with the twisting knob, thereby forming a horn-shaped space 33 with a slant wall 34.

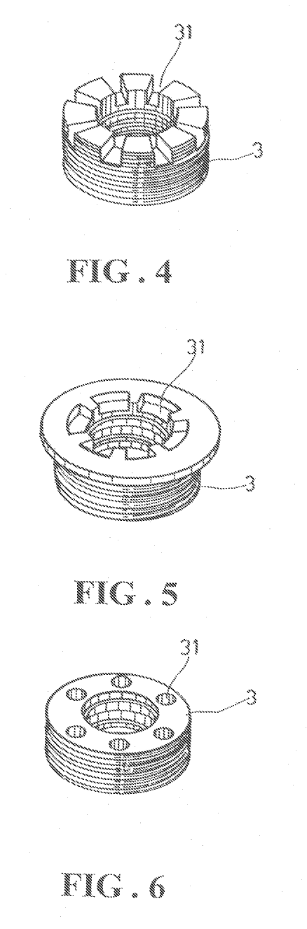

FIGS. 4, 5, and 6 illustrate a number of embodiment of the tubular screw 3. As shown, instead of having a twisting knob with bulges 31, the tubular screw 3 can have notches or holes 31 at an end of the tubular screw 3.

The coupling of the first and second pipes is shown in FIG. 7. First, the C-shaped ring 4 is embedded into the circular groove 11 of the first pipe 1. The first pipe 1 is then threaded sequentially through the tubular screw 3, the rubber ring 2, and the rubber washer 5. Subsequently, the giving end of the first pipe 1 is plugged into the receiving end of the second pipe 6. Please note that the rubber washer 5 is stopped at the slant section 62, and the rubber ring 2 becomes a buffer between the twisting knob of the tubular screw 3 and the receiving end of the second pipe 6. Please also note that the rubber washer 5 is slant at an end to match the slope of the slant section 62.

When the tubular screw 3 is screwed into the receiving end of the second pipe 6, the slant wall 34 forces the C-shaped ring 4, and thereby the giving end of the first pipe 1, to gradually advance until the giving end of the first pipe 1 is stopped at the circular flange 63. In the mean time, the bottom 32 of the tubular screw 3 presses the rubber washer 5 tightly against the slant section 62 to effectively prevent leakage.

A major feature of the present invention lies in the provision of the horn-shaped space 33 inside the tubular screw 3. The space 33 provides an adequate tolerance to compensate the difference in thermal expansion or contraction when the pipe coupling undergoes temperature variations. For example, when the temperature rises, if the second pipe 6 expands more than the first pipe 1, the tubular screw 3 can be further screwed into the second pipe 6 to prevent leakage. Similarly, when the temperature drops, if the second pipe 6 contracts more than the first pipe 1, the tubular screw 3 can be unscrewed a bit to prevent the pipe coupling from explosion. In addition to temperature changes, the tolerance provided by the present invention would also allow the pipe coupling to withstand the variations caused by physical impact.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device for coupling a giving end of a first pipe and a receiving end of a second pipe, said giving end having a circular groove around said first pipe, said receiving end having a plurality of threads around the inner wall and, further into said receiving end of said second pipe, having gradually shrunk diameter to form a slant section, said second pipe having a circular flange at the other end, comprising:
a C-shaped ring embedded in said circular groove;
a rubber ring;
a rubber washer having a slant end matching the slope of said slant section; and
a tubular screw having threads around the outer circumference and having gradually shrunk diameter from a second end to a first end, thereby forming a horn-shaped space with a slant wall;
wherein said giving end of said first pipe sequentially threads through said tubular screw via said first end, said rubber ring, and said rubber washer, and plugs into said receiving end of said second pipe; when said tubular screw is screwed into said receiving end of said second pipe, said slant wall forces said C-shaped ring, and thereby said giving end of said first pipe, to gradually advance until said giving end of said first pipe is stopped at said circular flange: and in the mean time, said second end of said tubular screw presses said rubber washer tightly against said slant section to effectively prevent leakage.

2. The device according to claim 1, wherein said first end of said tubular screw has a twisting knob with a plurality of bulges or a plurality of notches for screwing said tubular screw.
